(19) United States
(12) Patent Application Publication
(10) Pub. No.: US 2019/0075952 A1
(43) Pub. Date: Mar. 14, 2019

(54) NAPKIN SUSPENSION DEVICE

(71) Applicant: Sonia Elizabeth Uter, Brooklyn, NY (US)

(72) Inventor: Sonia Elizabeth Uter, Brooklyn, NY (US)

(21) Appl. No.: 16/124,430

(22) Filed: Sep. 7, 2018

Related U.S. Application Data
(60) Provisional application No. 62/557,457, filed on Sep. 12, 2017.

(51) Int. Cl. A47G 19/30; F16M 11/38

(52) U.S. Cl. CPC A47G 19/30; F16M 11/38

(57) ABSTRACT

A paper supporting device including a base having an upper surface and a lower surface. A support is upstanding from the upper surface of the base. A plurality of holders are disposed adjacent to a top edge of the support. The plurality of holders are configured to releasably secure at least two points of an edge of a paper to the support so that the paper is elevated above the base.

### CROSS-REFERENCE TO RELATED APPLICATION

This application claims the benefit of priority of U.S. provisional application No. 62/557,457, filed Sep. 12, 2017, the contents of which are herein incorporated by reference.

### BACKGROUND OF THE INVENTION

The present invention relates to supporting snacks and, more particularly, to a device for grasping the edges of a napkin to create a bowl like structure to support snacks therein.

When eating dry snacks, a napkin or paper towel may be used in lieu of a plate or bowl. This is because plates and bowls become dirty with each use, must be cleaned, and are too bulky for travel. When using a napkin or paper towel, the snacks may fall off while pouring, snacking, or during transporting to another location. Containing snacks or small items using napkins or paper towels alone can allow for spills, as they are either too flat or too unstable when lifted or cupped in hands.

As can be seen, there is a need for a more convenient and efficient device for containing snacks.

### SUMMARY OF THE INVENTION

In one aspect of the present invention, a paper supporting device comprises: a base comprising an upper surface and a lower surface; a support upstanding from the upper surface of the base; and a plurality of holders disposed adjacent to a top edge of the support, wherein the plurality of holders are configured to releasably secure at least two points of an edge of a paper to the support so that the paper is elevated above the base.

In another aspect of the present invention, the method of supporting a paper comprises steps of: providing a paper supporting device comprising: a base comprising an upper surface and a lower surface; a support upstanding from the upper surface of the base; and a plurality of holders disposed adjacent to a top edge of the support; and securing at least two points of an edge of the paper to the support via the holders so that the paper forms a bowl and is elevated above the base.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in use;

FIG. 2 is a perspective view of an embodiment of the present invention;

FIG. 3 is a section detail view of an embodiment of the present invention;

FIG. 4 is a perspective view of an embodiment of the present invention in a folded configuration for storage;

FIG. 5 is a perspective view of an embodiment of the present invention in an unfolded configuration;

FIG. 6 is a perspective view of an embodiment of the present invention shown in use;

FIG. 7 is a perspective view of an embodiment of the present invention;

FIG. 8 is a section detail view of an embodiment of the present invention;

FIG. 9 is a perspective view of an embodiment of the present invention in a folded configuration for storage; and

FIG. 10 is a perspective view of an embodiment of the present invention in an unfolded configuration.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention is a device that effectively contains dry snacks or small items, keeping them within the edges of the napkin or paper towel. The present invention, in conjunction with a napkin or paper towel, creates a reliable bowl structure that limits spills when pouring, eating, or walking with dry snacks or small items. Additionally, the present invention reduces the number of dirty dishes as the napkin or paper towel is suspended and is not touching or dirtying the device. Further, the napkin is discarded after each use throughout the day. It's also an efficient bowl for travel, being that it takes up less space.

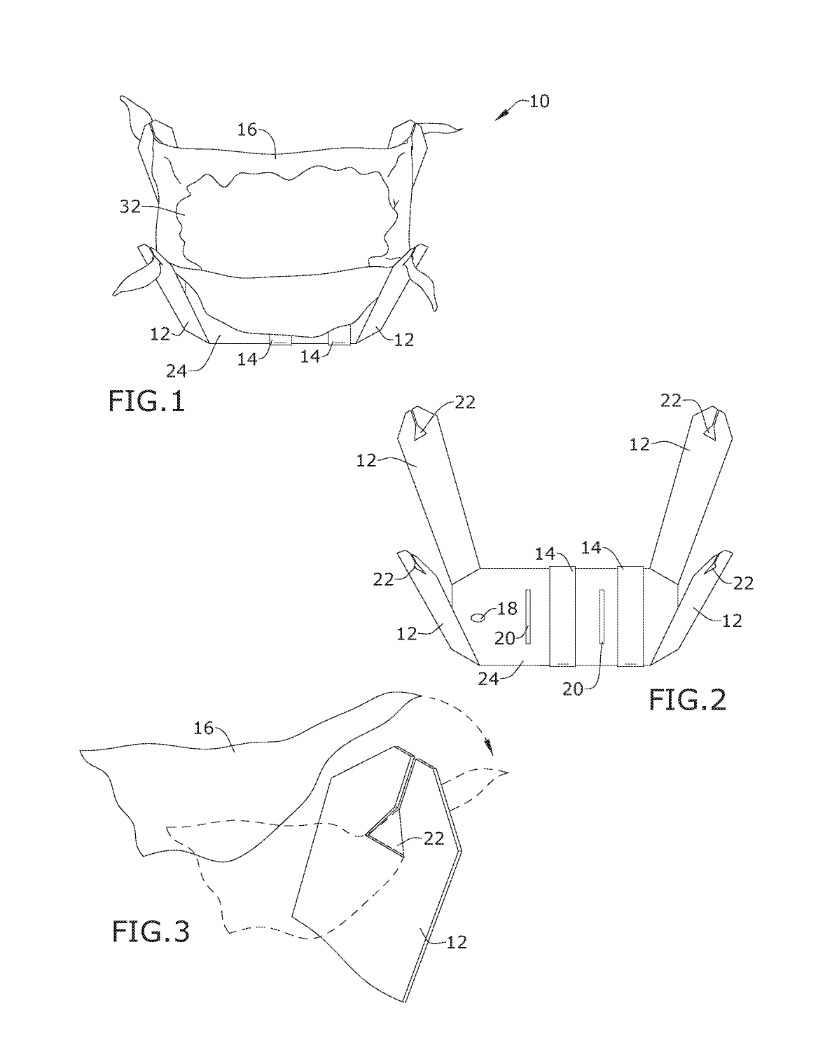

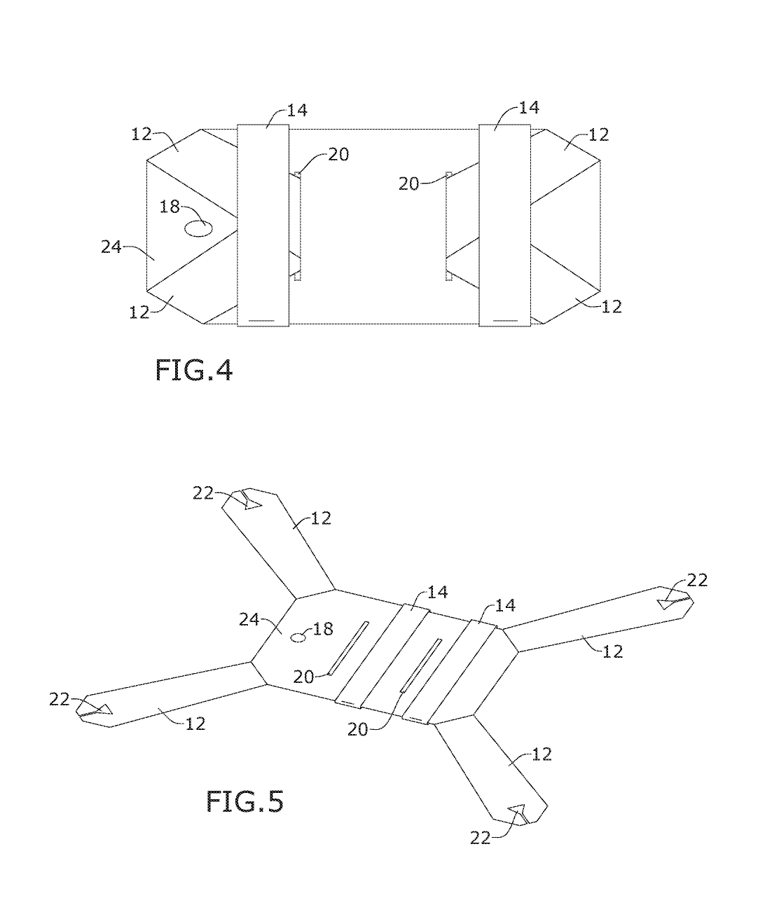

Referring to FIGS. 1 through 5, the present invention includes a paper supporting device 10. The paper supporting device 10 includes a base 24 having an upper surface and a lower surface. A support 12 is upstanding from the upper surface of the base 24. A plurality of holders 22 are disposed adjacent to a top edge of the support 12. The plurality of holders 22 are configured to releasably secure at least two points of an edge of a paper 16 to the support 12 so that the paper 16 is elevated above the base 24.

The base 24 may be substantially flat. The base 24 may include supports slits 20 formed therethrough. In such embodiments, the support 12 bends inward along a crease. A top end of the support 12 fits within the support slots 20 and the support slots 20 retain the support device 10 in a flat and folded configuration. The present invention may further include bands 14. The bands 14 may wrap around the base 24 and the support 12 such that the support 12 is disposed in between the bands 14 and the base 24. The bands 14 further retain the support device 10 in a flat and folded configuration. The base 24 may further include a hanger opening 18 formed therethrough. The hanger opening 18 may be used to hang the support device 10 on a hook when in a folded configuration.

In certain embodiments, the support 12 includes four arms upstanding from the base 24. The four arms may extend from four corners of the base 24. Each of the four arms includes one of the plurality of holders 22. In such embodiments, the edge of the paper 16 is attached to the support device 24 at four points. The four arms are upright when in use to suspend the corner or edges of the paper 16, such as a napkin or paper towel. The four arms may be folded inwards and inserted into the support slots 20. The bands 14 may further wrap around the arms and the base 24.

In certain embodiments, each the plurality of holders 22 may include a slit starting at the top edge of the support 12 and running downwards towards the base 24. For example, a slit may be formed at the top end of each of the four arms. An opening may be formed through the slit. A corner or edge of the paper 16 is inserted into the slit and slides into the opening. The slit and opening grasp the edges of the paper 16 and thereby support the paper 16 above the base 24 in a bowl shape. In alternate embodiments, the holders 22 may include clasps, clamps, ties, or other connectors capable of connecting an edge of the paper 16 to the support 12.

In an embodiment of the present invention, the support device 10 suspends a square sheet of napkin or paper towel (paper 16) and shapes the napkin or paper towel into a bowl-shaped container. The bowl-shaped container may contain a snack 32. The bowl-shaped container supports the snack 32 above the base 24, thereby preventing the support device 10 from getting dirty.

In one embodiment, the support device 10 works by inserting approximately 2″ of the corners of the paper 16 at each of the slits. The slits clamp the paper 16 into position. The tension of clamping the four corners of the paper 16 at the slits allows the support 12 to lift all edges of the paper 16. The paper 16 is supported as a bowl shape container as the edges are lifted into an upright position while in use. The bottom of the paper 16 can be suspended above (or rested onto) the base 24 of the support device 10. Snacks 32 may be contained within the bowl-shaped container. The base 24 rests on a flat surface and is held underneath while being transported from one surface to another. When not in use, the support 12 folds flat to the base 24 and can be inserted into the support slots 20 and held down by the bands 14.

The present invention may be created by die cutting a thin flexible plastic shape of the supports 12 and base 24 as one part, and folding the supports 12 upwards at the bent edge during use. In certain embodiments, the material used for the support device 10 is rubberized to have a non-slip surface.

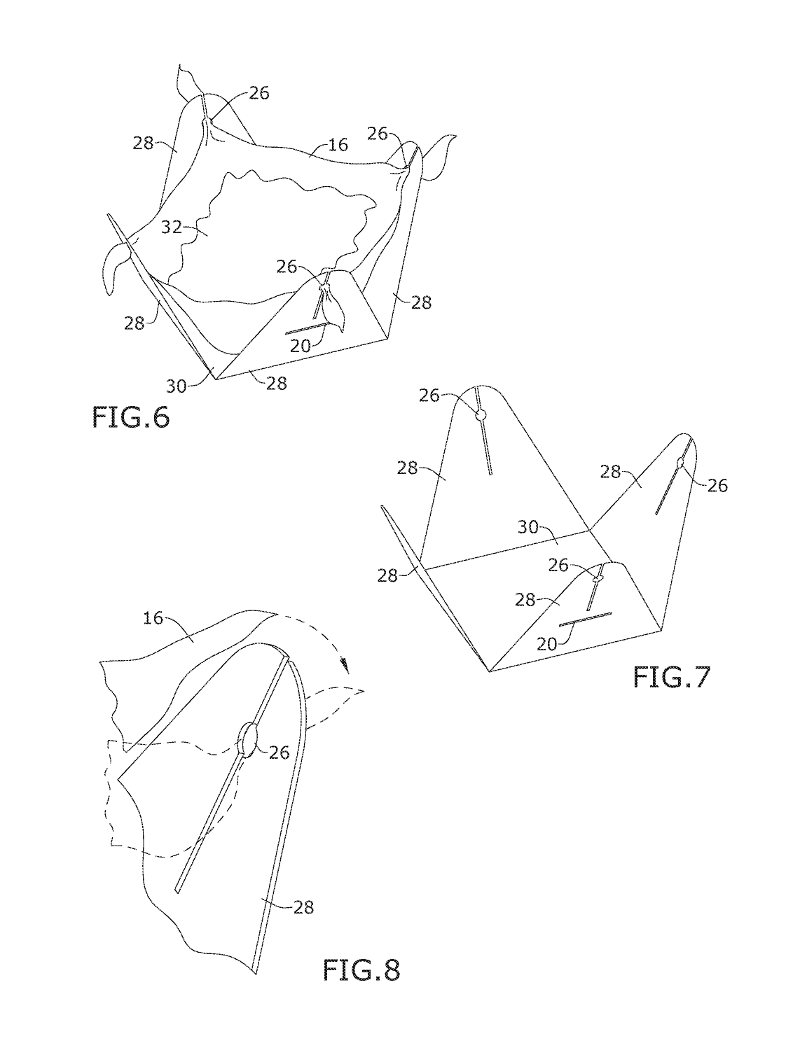

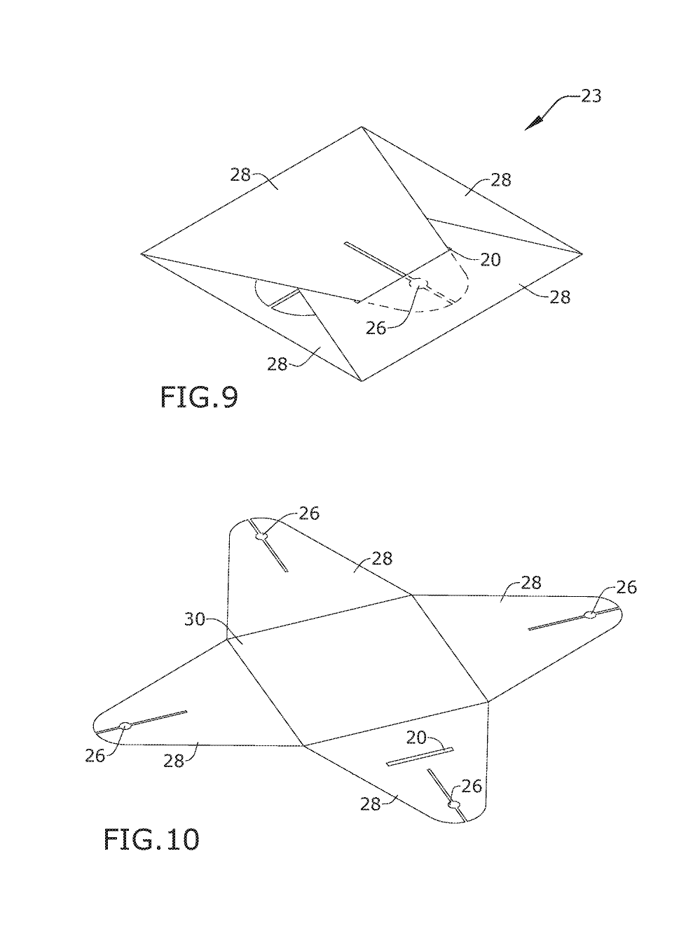

Referring to FIGS. 6 through 10, the present invention includes a paper supporting device 23. The paper supporting device 23 includes a base 30 having an upper surface and a lower surface. A support 28 is upstanding from the upper surface of the base 30. A plurality of holders 26 are disposed adjacent to a top edge of the support 28. The plurality of holders 26 are configured to releasably secure at least two points of an edge of a paper 16 to the support 28 so that the paper 16 is elevated above the base 30.

In certain embodiments, the support 28 includes four arms upstanding from the base 30. The four arms may extend from four sides of the base 30. Each of the four arms includes one of the plurality of holders 26. The four arms are upright when in use to suspend the corner or edges of the paper 16, such as a napkin or paper towel. The four arms may be folded inwards in a folded configuration. Once of the four arms may include a slot 20. Another of a top end of the arms fits within the slot 20 to contain the present invention in the folded configuration.

In certain embodiments, each the plurality of holders 26 may include a slit starting at the top edge of the support 28 and running downwards towards the base 30. For example, a slit may be formed at the top end of each of the four arms. An opening may be formed through the slit. A corner or edge of the paper 16 is inserted into the slit and slides into the opening. The slit and opening grasp the edges of the paper 16 and thereby support the paper 16 above the base 30 in a bowl shape. In alternate embodiments, the holders 26 may include clasps, clamps, ties, or other connectors capable of connecting an edge of the paper 16 to the support 28.

In one embodiment, this device can be made to hold plastic wrap. The device can also include a waterproof tarp to hold wet objects with a tighter clamping device.

In one embodiment, to provide a more sturdy and structured device, the device material can be a hard plastic, metal, wood, or bamboo. Further, hinges can replace bent edges. In an alternative embodiment, the device can also be metal wire, bent into the same or similar functioning shape. The device can also be a hard-plastic, molded shape, metal casted shape, or carved wooden shape with arms in permanent upright position.

In one embodiment, the bent edge can be reconfigured into a scored, or thinner edge for better flexibility on a thick but pliable plastic. The bent edge can also be changed to have a hard hinge that pivots the arms as needed.

In one embodiment, this device can be scaled larger to hold a bigger tarp, (i.e. beach towel) or to hold larger items as a part of an extended product line.

In one embodiment, the overall shape of the device can also be reconfigured into two sets of rods with arms at both ends. Both arms have a clamping feature at a top edge to hold the paper towel or napkin. The two rods are fixed with a pivoting center to create an “X” shape when open and in use. Rods and/or posts can fold straight and flat for optimal space when stored.

Sample instructions for using the device are as follows: Unfold the device onto a flat surface. Move the posts in an upright position keeping the base parallel to the flat surface. Take a square napkin or paper towel and insert 2″-3″ of one corner into the slit at the top edge of one of the arms until it gathers in the slit (the tip of the corner should face away from the base). At this step, the body of the napkin or paper towel should be resting at the topside of the base. Repeat inserting the balance corners of the napkin or paper towel into the three other slits accordingly. This will create a bowl structure using the napkin or paper towel. Add dry snacks or small items as needed. When finished, remove and bunch together all corners of the napkin or paper towel and discard. If using a reusable fabric napkin, wash, reuse, and add as needed for each use. When the device is not in use, fold all arms down to the topside of base. If applicable, insert the arms into base slots and wrap the bands around to secure arms in flat position.

It should be understood, of course, that the foregoing relates to exemplary embodiments of the invention and that modifications may be made without departing from the spirit and scope of the invention as set forth in the following claims.

What is claimed is:

1. A paper supporting device comprising:
a base comprising an upper surface and a lower surface;
a support upstanding from the upper surface of the base; and
a plurality of holders disposed adjacent to a top edge of the support, wherein
the plurality of holders are configured to releasably secure at least two points of an edge of a paper to the support so that the paper is elevated above the base.

2. The paper supporting device of claim 1, wherein the support comprises four arms upstanding from the base, wherein each of the four arms comprises one of the plurality of holders.

3. The paper support device of claim 2, wherein the four arms are extending from four corners of the base.

4. The paper support device of claim 2, wherein the four arms are extending form four sides of the base.

5. The paper supporting device of claim 1, wherein each the plurality of holders comprises a slit starting at the top edge of the support and running downwards towards the base.

6. The paper supporting device of claim 3, further comprising a plurality of openings defined through the support at each of the slits.

7. The paper supporting device of claim 1, wherein the base comprises support slots, wherein ends of the support insert into the support slots in a folded configuration.

8. The paper supporting device of claim 1, further comprising bands wrapped around the base, wherein ends of the support are disposed in between the bands and the base in a folded configuration.

9. The paper supporting device of claim 1, wherein the base comprises an hanger opening formed therethrough.

10. The method of supporting a paper comprising steps of:
providing a paper supporting device comprising:
a base comprising an upper surface and a lower surface;
a support upstanding from the upper surface of the base; and
a plurality of holders disposed adjacent to a top edge of the support; and
securing at least two points of an edge of the paper to the support via the holders so that the paper forms a bowl shape and is elevated above the base.

11. The method of claim 10, wherein the support comprises four arms upstanding from the base, wherein each of the four arms comprises one of the plurality of holders.

12. The method of claim 11, wherein the four arms are extending from four corners of the base.

13. The method of claim 11, wherein the four arms are extending form four sides of the base.

14. The method of claim 10, wherein each the plurality of holders comprises a slit starting at the top edge of the support and running downwards towards the base.

15. The method of claim 14, wherein the step of securing at least two points of the edge of the paper to the support comprises the step of inserting the edge of the paper within the slits.
